(19) United States
(12) Patent Application Publication
(10) Pub. No.: US 2009/0073485 A1
(43) Pub. Date: Mar. 19, 2009

(54) IMAGE FORMING SYSTEM AND CONTROL METHOD THEREOF

(75) Inventors: Yuya Oka, Mishima-shi (JP); Fumiyoshi Kittaka, Yokohama-shi (JP); Yasukazu Kobayashi, Sunto-gun (JP)

Correspondence Address: AMIN, TUROCY & CALVIN, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 11/855,471

(22) Filed: Sep. 14, 2007

(51) Int. Cl. G06F 3/12

(52) U.S. Cl. 358/1.15

(57) ABSTRACT

An image forming system according to the present invention includes plural image forming apparatuses equipped with control panels and a server that is connected to the respective image forming apparatuses through a network and manages data of a user interface commonly usable in the respective control panels of the respective image forming apparatuses and supplies the user interface to the respective image forming apparatuses. In this image forming system, even when user interfaces of the respective image forming apparatuses are originally different from each other, it is possible to realizes, for each user or for each department, a common user interface on the control panels.

### BACKGROUND OF THE INVENTION

1. Field of the Invention

The present invention relates to an image forming system and a control method thereof, and, more particularly to an image forming system in which image forming apparatuses such as copying machines and a network apparatus such as a server are connected through a network and a control method thereof.

2. Description of the Related Art

In an image forming apparatus such as a copying machine or an MFP (Multi-Function Peripheral), a control panel for user operation is usually provided. The control panel includes a display panel with touch panels and operation buttons. The user operates the image forming apparatus by depressing the touch panels and the operation buttons while looking at the display panel.

On the other hand, according to the recent spread of the network technique, it is also possible to remotely operate the image forming apparatus using a personal computer or the like from a location remote from the image forming apparatus.

For example, JP-A-2001-175382 discloses a technique for causing a display screen of a personal computer to display a control panel having functions same as those of a control panel of an image forming apparatus such as a copying machine and allowing a user to operate the image forming apparatus even from a remote location by clicking the control panel on the display screen of the personal computer. In the technique disclosed in JP-A-2001-175382, image data of the control panel generated by the image forming apparatus is transferred to the personal computer and displayed on the personal computer. Therefore, display contents on the control panel of the image forming apparatus and display contents on the personal computer are completely the same.

On the other hand, in offices of these days, plural image forming apparatuses are often set in the same building or on the same floor. In general, although basic functions such as copying of the image forming apparatuses are not different, improvement of performance and an increase in functions of various sections of the image forming apparatuses are always performed. Therefore, in image forming apparatuses purchased in different periods or manufactured by different manufacturers, display contents and operation contents (the display contents and the operation contents may be hereinafter collectively referred to as user interfaces) of control panels are different from one another.

Consequently, a user need to learn and get accustomed to user interfaces corresponding to the control panels of the respective image forming apparatuses. This is extremely complicated for the user.

The technique disclosed by JP-A-2001-175382 adopts a form for capturing image data of a control panel peculiar to a specific image forming apparatus into a personal computer and causing the personal computer to display the image data. Therefore, when plural image forming apparatuses are connected to a network and it is attempted to operate the respective image forming apparatuses from one personal computer, a user interface different for each of the image forming apparatuses is displayed on the personal computer. This is inconvenient for the user.

### SUMMARY OF THE INVENTION

The present invention has been devised in view of the circumstances and it is an object of the present invention to provide an image forming system in which plural image forming apparatuses are connected through a network, wherein, even when user interfaces of the respective image forming apparatuses are originally different from each other, a common user interface can be used for each user or each department, and a control method of the image forming system.

In order to attain the object, an image forming system according to an aspect of the present invention includes plural image forming apparatuses equipped with control panels and a server that is connected to the respective image forming apparatuses through a network and manages data of a user interface commonly usable in the respective control panels of the respective image forming apparatuses and supplies the user interface to the respective image forming apparatuses.

In order to attain the object, a control method of an image forming system according to another aspect of the present invention is a control method of an image forming system that includes plural image forming apparatuses equipped with control panels and a server connected to the respective image forming apparatuses through a network, the control method including the steps of managing, in the server, data of a user interface commonly usable in the respective control panels of the respective image forming apparatuses and supplying the data of the user interface from the server to the respective image forming apparatuses.

### BRIEF DESCRIPTION OF THE DRAWINGS

In the accompanying drawings:

FIG. 1 is a diagram showing an example of the structure of an image forming system according to a first embodiment of the present invention;

FIG. 2 is a diagram showing a control panel of an image forming apparatus and a first display example of a display device of an information processing apparatus that remotely operates the image forming apparatus;

FIG. 3 is a diagram showing the control panel of the image forming apparatus and a second display example of the display device of the information processing apparatus that remotely operates the image forming apparatus;

FIG. 4 is a diagram conceptually showing an example of a UI database of a UI server;

FIG. 5 is a flowchart showing an example of processing by the image forming apparatus according to the first embodiment;

FIG. 6 is a diagram showing a first operation example for realizing a general user interface on the information processing apparatus in the image forming system according to the first embodiment;

FIG. 7 is a diagram showing a second operation example for realizing the general user interface on the information processing apparatus in the image forming system according to the first embodiment;

FIG. 8 is a flowchart showing an example of processing by the UI server;

FIG. 9 is a diagram showing a first operation example for realizing a specific user interface on the information processing apparatus in the image forming system according to the first embodiment;

FIG. 10 is a diagram showing a second operation example for realizing the specific user interface on the information processing apparatus in the image forming system according to the first embodiment;

FIG. 11 is a diagram showing a third operation example for realizing the specific user interface on the information processing apparatus in the image forming system according to the first embodiment;

FIG. 12 is a diagram showing an example of the structure of an image forming system according to a second embodiment of the present invention;

FIG. 13 is a flowchart showing an example of processing by an image forming apparatus according to the second embodiment;

FIG. 14 is a diagram showing an operation example for realizing a general user interface on a control panel in the image forming system according to the second embodiment; and

FIG. 15 is a diagram showing an operation example for realizing the specific user interface on the control panel in the image forming system according to the second embodiment.

### DETAILED DESCRIPTION OF THE INVENTION

Embodiments of an image forming system and a control method thereof according to the present invention will be hereinafter explained in detail with reference to the accompanying drawings.

### (1) Structure of an Image Forming System

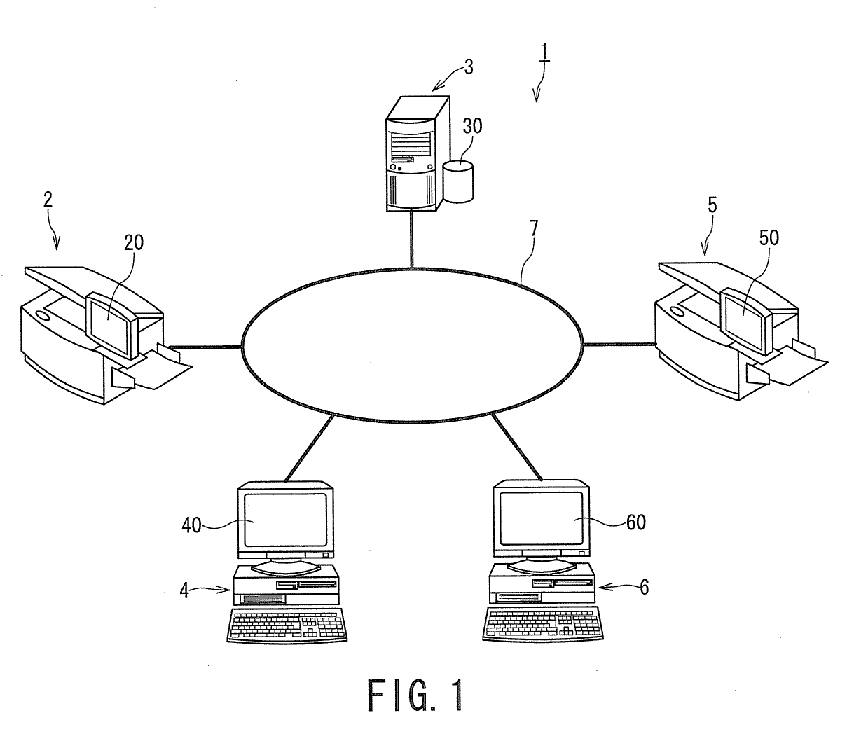

FIG. 1 is a diagram showing an example of the structure of an image forming system 1 according to a first embodiment of the present invention. The image forming system 1 includes plural image forming apparatuses (2 and 5), one or more information processing apparatuses (4 and 6), and a UI server 3, which are connected to one another through a network 7.

In FIG. 1, the two image forming apparatuses 2 and 5 and the two information processing apparatuses 4 and 6 are illustrated. However, the numbers of the image forming apparatuses and the information processing apparatuses are not limited to those illustrated in FIG. 1.

The image forming apparatus 2 and the image forming apparatus 5 are, for example, copying machines or MFPs that realize plural functions such as a copying function, a scanner function, and a FAX function alone. The image forming apparatus 2 and the image forming apparatus 5 have slightly different functions and performance. Therefore, display contents and operation contents (i.e., user interfaces) of control panels 20 and 50 included in these image forming apparatuses are originally different from each other.

The information processing apparatuses 4 and 6 are, for example, personal computers and are used for remotely operating the image forming apparatuses 2 and 5. The information processing apparatuses 4 and 6 have display devices 40 and 60, respectively. User interfaces for operating the image forming apparatuses 2 and 5 are displayed on the display devices 40 and 60.

The UI server 3 is information processing means having user interface data (hereinafter referred to as UI data; a set of UI data is referred to as a UI database 30) described later. The UI server 3 may be a personal computer.

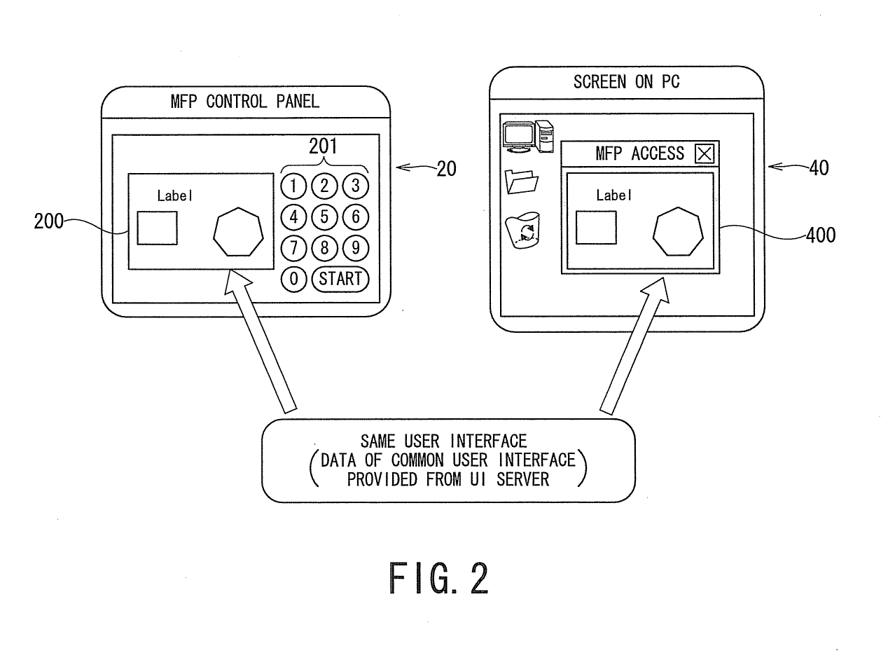

FIG. 2 is a diagram illustrating an overview of operations according to this embodiment. A figure on the left in FIG. 2 schematically shows the control panel 20 of the image forming apparatus 2. The control panel 20 has a display operation unit 200 and a key operation unit 201.

The key operation unit 201 has a ten key, a start key, and the like. A user operates the key operation unit 201 to, for example, set the number of copies and start copying.

The display operation unit 200 has, for example, the structure in which a liquid crystal display and a touch panel are laid one on top of the other. Display contents (graphics of a square, a polygon, and the like) of the display operation unit 200 shown in FIG. 2 are for convenience of explanation only. Actually, various images for operation corresponding to respective functions realized by the image forming apparatus 2 such as a copy enlargement and reduction function, a copy density selection function, a sheet selection function, and a facsimile function and display images for operation support (these individual images are hereinafter referred to as icons) are arranged and displayed in appropriate positions. In other words, a user interface of the image forming apparatus 2 is displayed on the display operation unit 200.

On the right in FIG. 2, a display example of the display device 40 of the information processing apparatus 4 is shown. In an MFP access window 400 of the display device 40, a user interface same as that on the display operation unit 200 of the control panel 20 is displayed.

In the image forming system 1 according to this embodiment, data for these user interfaces (UI data) can be provided from the UI server 3 as common UI data rather than being outputted from main bodies of the respective image forming apparatuses.

As a result, even if the original user interfaces of the control panels of the respective image forming apparatuses 2 and 5 are different because of a difference in functions due to options, a difference in manufacturers, or a difference in purchase periods, it is possible to provide a user interface common to the respective image forming apparatuses 2 and 5. By using this common user interface, it is possible to realize the same display and the same operation in the control panels 20 and 50 of the respective image forming apparatuses 2 and 5.

When the same employee A remotely operates the respective image forming apparatuses 2 and 5 using the information processing apparatus 4, it is possible to realize the same display and the same operation on the information processing apparatus 4 by using the common user interface.

As described later, in this embodiment, it is possible to handle a user interface customized for each user or each department. As a result, it is possible to realize a more flexible system.

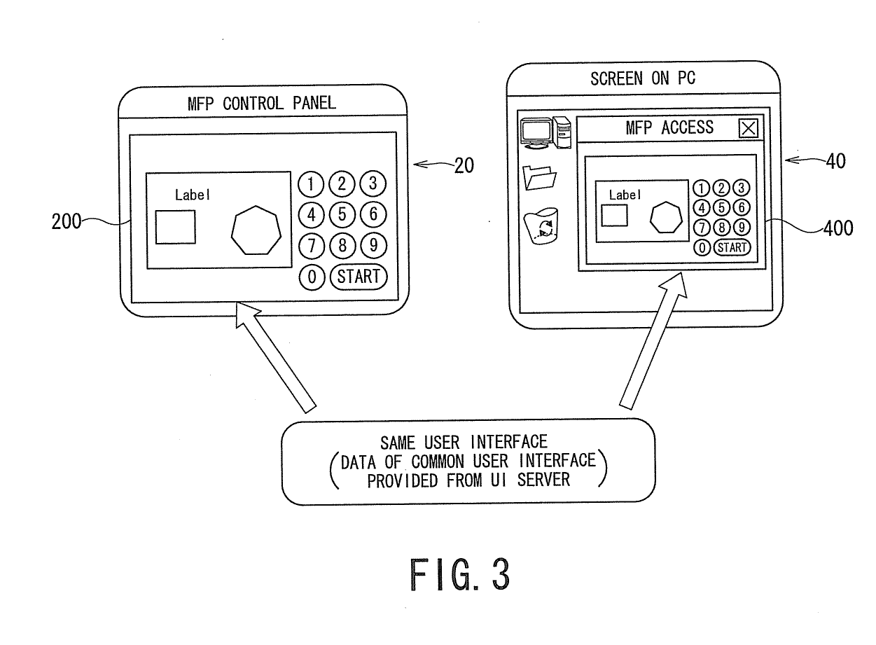

According to a technique for increasing a size of a liquid crystal display in these days, as shown in FIG. 3, it is also possible to freely arrange the entire control panel including operation keys from the outside using UI data. In this case, it is possible to form a user interface realized by a control panel of an image forming apparatus and a user interface realized in an information processing apparatus completely the same. The effect of this embodiment is further improved.

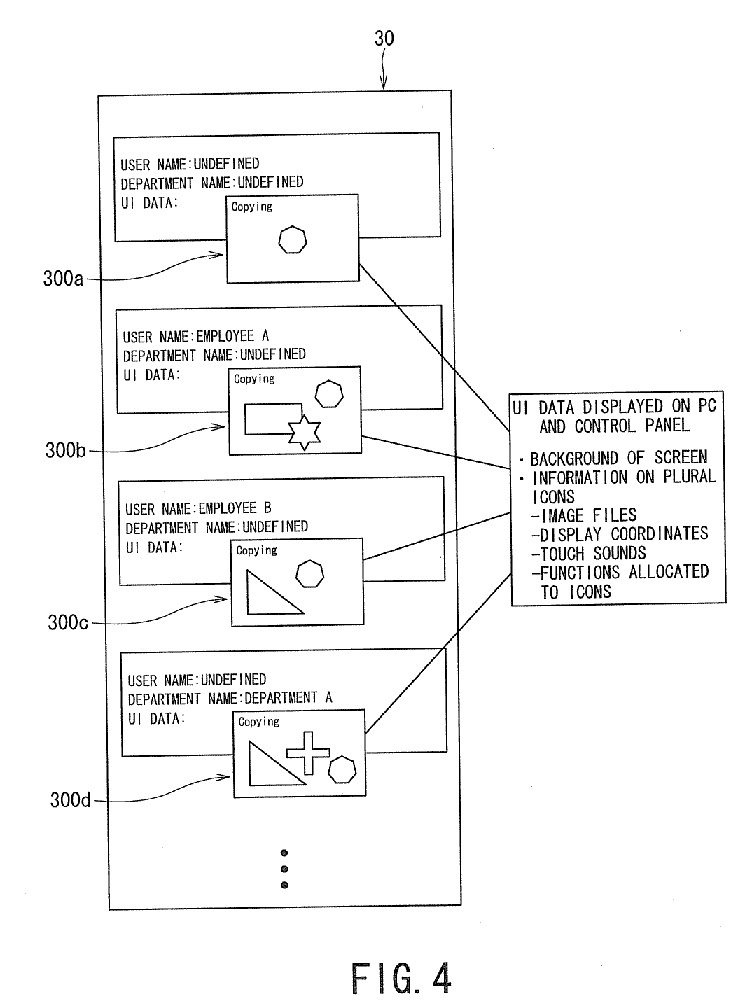

FIG. 4 is a diagram showing an example of a set of UI data (a UI database 30) included in the UI server 3. Among the set of UI data, UI data 300a is data of a general user interface in which a user name and a department name are undefined. In other words, the UI data 300a is UI data that anybody can use.

UI data 300b, 300c, and 300d are data of specific user interfaces in which at least one of user names and department names are defined. For example, the UI data 300b is UI data exclusive for an employee A, the UI data 300c is UI data exclusive for an employee B, and UI data 300d is UI data exclusive for a department A. Any member belonging to the department A can use the UI data 300d but users other than members of the department A cannot use the UI data 300d.

The data of the specific user interfaces can be customized. For example, in the UI data 300b, the employee A can change shapes, an arrangement, and the like of icons to suit convenience of the employee A.

The respective UI data include background images of display screens and plural pieces of icon information. The icon information includes information on image files, display coordinates, and touch sounds of respective icons and functions allocated to the respective icons.

### (2) Operations

Operations of the image forming system 1 constituted as described above are explained below.

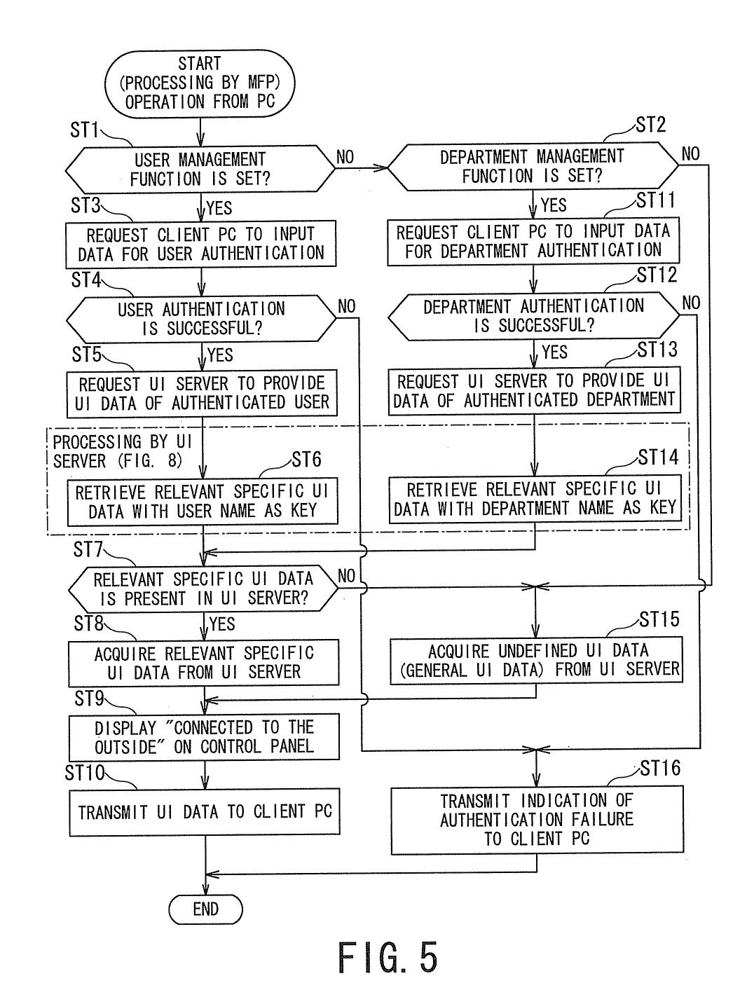

FIG. 5 is a flowchart showing an example of processing in the image forming apparatus 2 among the operations of the image forming system 1 according to the first embodiment (a form of an operation in a mode of remote operation from a client PC (the information processing apparatus 4)).

Processing for remotely operating the image forming apparatus 5 using the information processing apparatus 4, and processing for remotely operating the image forming apparatus 2 and the image forming apparatus 5 using the information processing apparatus 6 are basically the same as processing for remotely operating the image forming apparatus 2 using the information processing apparatus 4. Therefore, in the following explanation, an example of the processing for remotely operating the image forming apparatus 2 using the information processing apparatus 4 is mainly explained.

First, in step ST1 and step ST2, the image forming apparatus 2 determines whether a user management function or a department management function is set in the image forming apparatus 2. In this embodiment, a specific user or a specific department can customize a specific user interface exclusive for the user or the department in advance and register the specific user interface in the UI server 3.

On the other hand, a general user interface in which a user and a department of which are undefined and that can be used by anybody is also registered in the UI server 3. When the user management function and the department management function are not set in the image forming apparatus 2, the general user interface can be used. A user and a department that have not registered specific user interfaces for the user and the department can use the general user interface.

Thus, in steps ST1 and ST2, the image forming apparatus 2 determines whether the user management function or the department management function is set in the image forming apparatus 2. When both the user management function and the department management function are not set, the image forming apparatus 2 proceeds to step ST15 and acquires general UI data in which a user and a department are undefined from the UI server 3.

When the general UI data is acquired from the UI server 3, the image forming apparatus 2 displays an indication “connected to the outside” on the control panel 20 of the image forming apparatus 2 (step ST9). This is for the purpose of notifying a user who attempts to directly use the image forming apparatus 2 in a local mode that the image forming apparatus 2 is remotely operated from the information processing apparatus 4 on the outside.

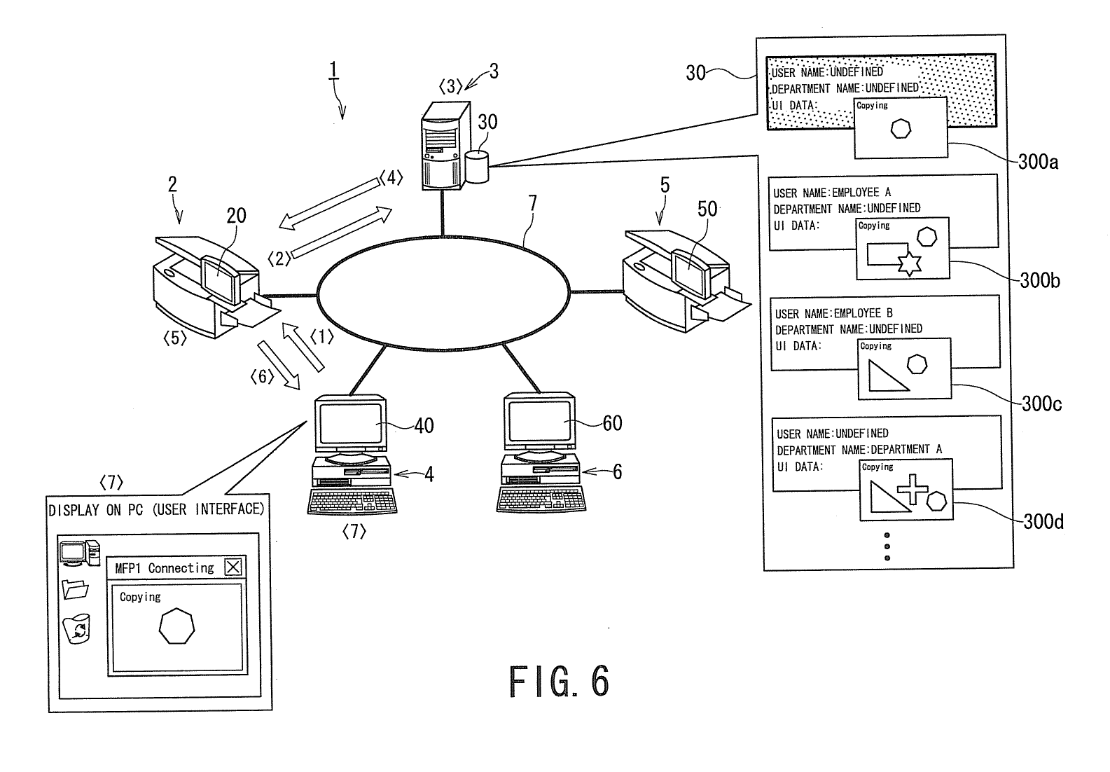

The acquired general UI data is transmitted to the client PC (the information processing apparatus 4) and served for operation in the information processing apparatus 4 (step ST10) FIG. 6 is a diagram schematically showing, on a diagram of the image forming system 1, a process until the general user interface is realized on the information processing apparatus 4 when the image forming apparatus 2 is remotely operated using the information processing apparatus 4.

First, the image processing apparatus 4 performs access of remote operation to the image forming apparatus 2 in which both the user management function and the department management function are not set (<1> in FIG. 6). In response to this access, the image forming apparatus 2 requests the UI server 3 to provide the general UI data 300a in which a user and a department are undefined (<2> in FIG. 6).

The UI server 3 retrieves the UI data 300a from the UI database 30 (<3> in FIG. 6) and outputs the UI data 300a to the image forming apparatus 2 (<4> in FIG. 6).

The image forming apparatus 2 displays an indication “connected to the outside” on the control panel 20 (<5> in FIG. 6) and outputs the UI data 300a to the information processing apparatus 4 (<6> in FIG. 6).

The information processing apparatus 4 causes the display device 40 to display a user interface image based on the inputted UI data 300a and realizes an operation environment associated with an icon of the user interface image (<7> in FIG. 6).

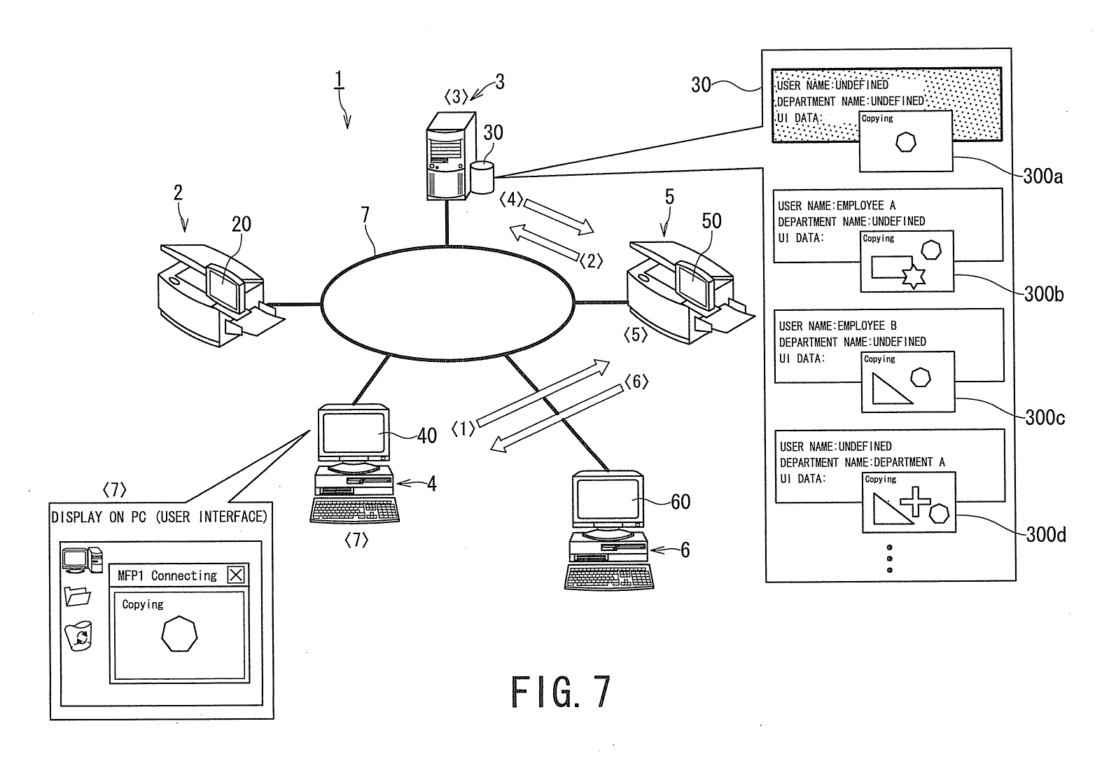

FIG. 7 is a diagram schematically showing a process until the general UI data is provided to the information processing apparatus 4 when the image forming apparatus 5 is remotely operated using the information processing apparatus 4. The process including data exchanged and contents of processing is the same as that shown in FIG. 6 except that an access destination of the information processing apparatus 4 is changed from the information processing apparatus 2 to the information processing apparatus 5.

As it is seen from FIGS. 6 and 7, even when the image forming apparatus 2 and the image forming apparatus 5 of different models are remotely operated, user interfaces realized on the information processing apparatus 4 are based on the same UI data 300a provided from the UI server 3. Therefore, even if original user interfaces are different in the image forming apparatus 2 and the image forming apparatus 5, the user can use, on the information processing apparatus 4, the common general user interface registered in the UI server 3. Therefore, convenience for the user is improved.

Referring back to FIG. 5, when the user management function is set in the image forming apparatus 2, the image forming apparatus 2 requests the client PC (the information processing apparatus 4) to input data for user authentication (step ST3). When the user authentication is successful (YES in step ST4), the image forming apparatus 2 requests the UI server 3 to provide specific UI data exclusive for an authenticated user (step ST5) In this case, the image forming apparatus 2 passes a name of the authenticated user to the UI server 3 as a key for retrieval.

Similarly, when the department management function is set in the image forming apparatus 2, the image forming apparatus 2 requests the client PC (the information processing apparatus 4) to input data for department authentication (step ST11). When the department authentication is successful (YES in step ST12), the image forming apparatus 2 requests the UI server 3 to provide specific UI data exclusive for an authenticated department (step ST13). In this case, as in the above case, the image forming apparatus 2 passes a name of the authenticated department to the UI server 3 as a key.

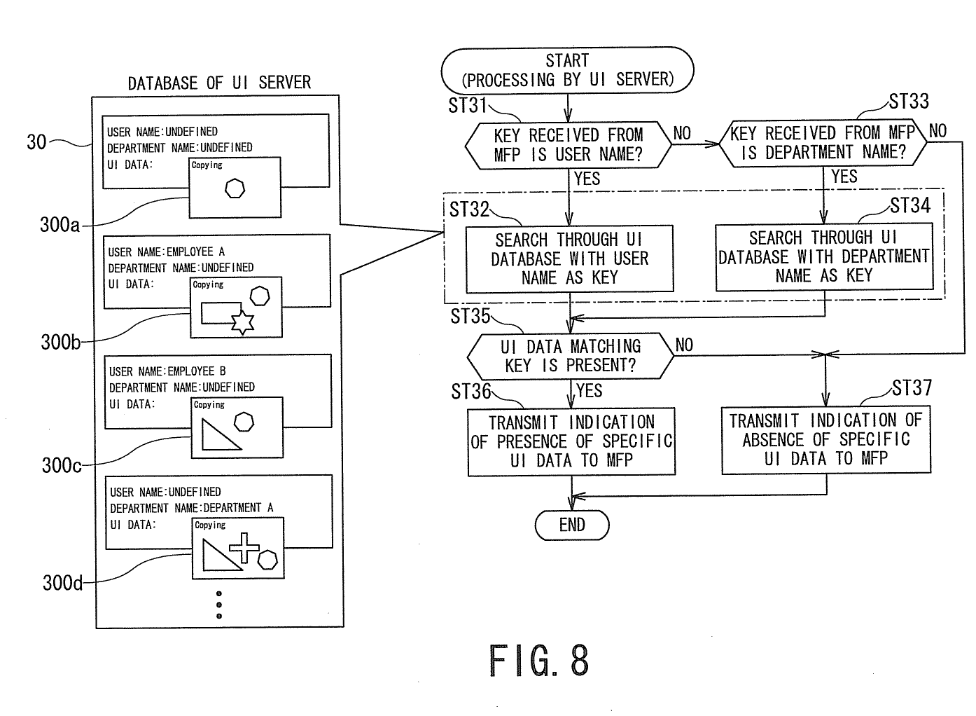

Steps ST6 and ST14 are processing performed by the UI server 3. More detailed contents of the steps are shown in FIG. 8.

FIG. 8 is a flowchart showing an example of the processing performed by the UI server 3. The UI server 3 determines whether the key passed from the image forming apparatus 2 is the user name or a department name (steps ST31 and ST33).

When the key is the user name, the UI server 3 searches through the UI database 30 with the user name as a key (step ST32) When the key is the department name, the UI server 3 searches through the UI database 30 with the department name as a key (step ST34).

When UI data defined by the user name or the department name matching the key is present in the UI database 30 (YES in step ST35), the UI server 3 transmits an indication “specific UI data is present” to the image forming apparatus 2 (step ST36). When the UI data is absent (NO in step ST35), the UI server 3 transmits an indication “specific UI data is absent” to the image forming apparatus 2 (step ST37).

When relevant specific UI data is present in the UI server 3 (YES in step ST7), the image forming apparatus 2 acquires the specific UI data from the UI server 3 (step ST8 in FIG. 5).

On the other hand, when relevant specific UI data is absent in the UI server 3 (NO in step ST7), the image forming apparatus 2 acquires the general UI data in which a user name and a department name are undefined from the UI server 3 (step ST15). After displaying an indication “connected to the outside” on the control panel 20 of the image forming apparatus 2 (step ST9), the image forming apparatus 2 transmits the acquired specific UI data or general UI data to the client PC (the information processing apparatus 4) (step ST10)

When the authentication is failed in step ST4 or step ST12, the image forming apparatus 2 transmits an indication of failure in the authentication to the client PC (the information processing apparatus 4) and finishes the processing.

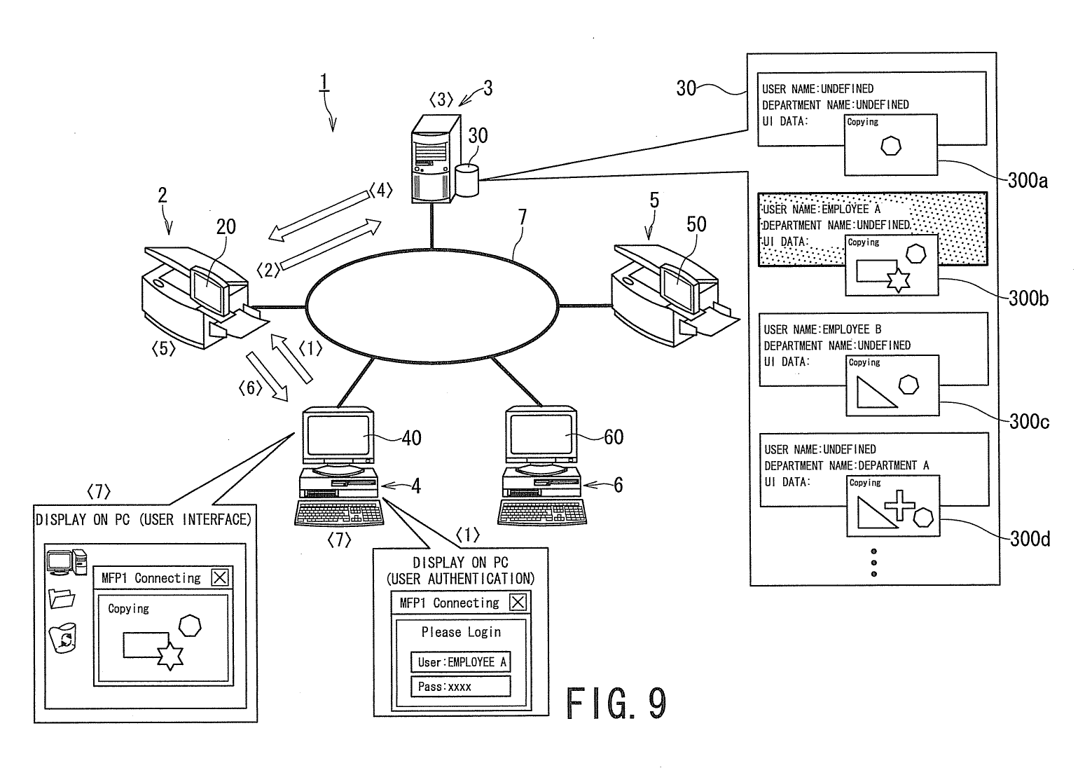

FIG. 9 is a diagram schematically showing, as in FIG. 6, on the diagram of the image forming system 1, a process until the specific user interface is realized on the information processing apparatus 4 when the image forming apparatus 2 is remotely operated using the information processing apparatus 4.

First, the information processing apparatus 4 performs access of remote operation to the image forming apparatus 2 in which the user management function is set. The image forming apparatus 2 requests the information processing apparatus 4 to input authentication data. In response to this request, the information processing apparatus 4, on the screen of the display device 40, displays an input screen for a user name and a password and urges the user to input a user name and a password of the user. The user inputs a user name (in an example in FIG. 9, “employee A”) and a password on this input screen and transmits the user name and the password to the image forming apparatus 2 (<1> in FIG. 9).

The image forming apparatus 2 performs user authentication on the basis of the user name (employee A) and the password. When the authentication is successful, the image forming apparatus 2 requests the UI server 3 to provide the specific UI data 300b for the employee A. In this case, the image forming apparatus 2 sends the request together with the user name (employee A) (<2> in FIG. 9)

The UI server 3 retrieves the specific UI data 300b from the UI database 30 with the user name (employee A) as a key (<3> in FIG. 6) and outputs the specific UI data 300b to the image forming apparatus 2 (<4> in FIG. 9).

The image forming apparatus 2 displays an indication “connected to the outside” on the control panel 20 (<5> in FIG. 9) and outputs the specific UI data 300b to the information processing apparatus 4 (<6> in FIG. 9).

The information processing apparatus 4 causes the display device 40 to display a user interface image based on the inputted specific UI data 300b and realizes an operation environment associated with an icon of the user interface image (<7> in FIG. 9).

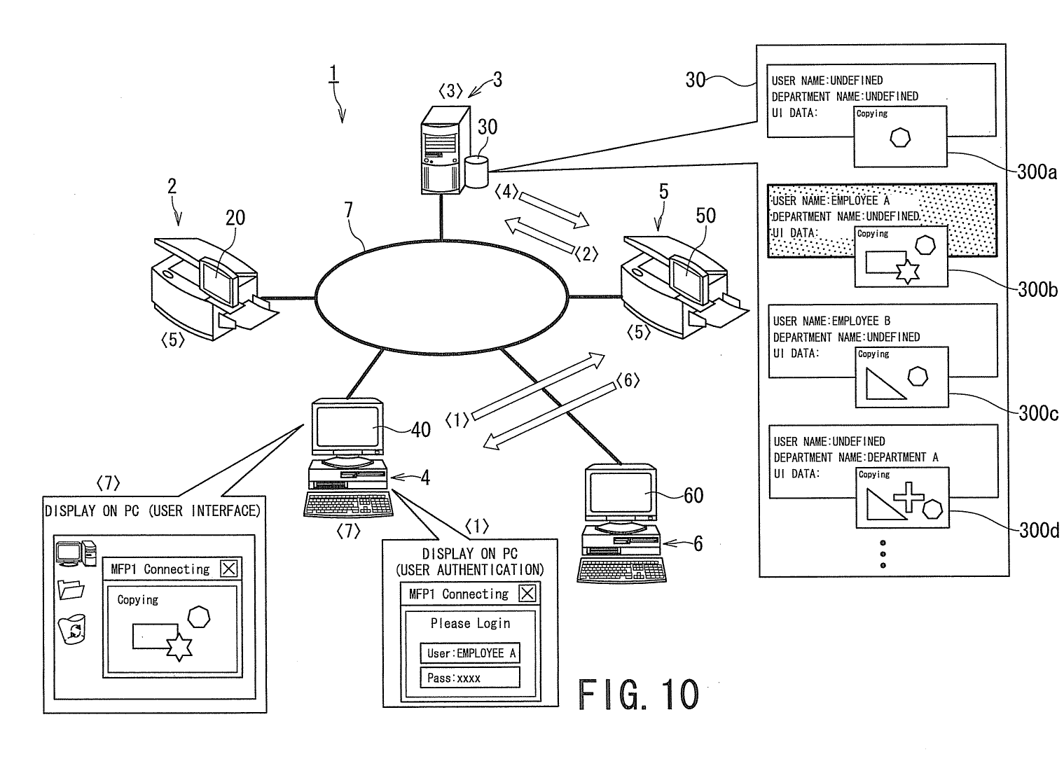

FIG. 10 is a diagram schematically showing a process until specific UI data is provided to the information processing apparatus 4 when the information processing apparatus 4 remotely operates the image forming apparatus 5. The process including data exchanged and contents of processing is the same as that shown in FIG. 9 except that an access destination of the information processing apparatus 4 is changed from the information processing apparatus 2 to the information processing apparatus 5.

As it is seen from FIGS. 9 and 10, even when the image forming apparatus 2 and the image forming apparatus 5 of different models are remotely operated, user interfaces realized on the information processing apparatus 4 are based on the same specific UI data 300b provided from the UI server 3. Therefore, even if original user interfaces are different in the image forming apparatus 2 and the image forming apparatus 5, the user can use, on the information processing apparatus 4, the common specific user interface registered in the UI server 3. Therefore, convenience for the user is improved. Moreover, in the case of the specific user interface, for example, the employee A can customize shapes and an arrangement of icons according to the preference of the employee A. It is possible to realize a more convenient user interface.

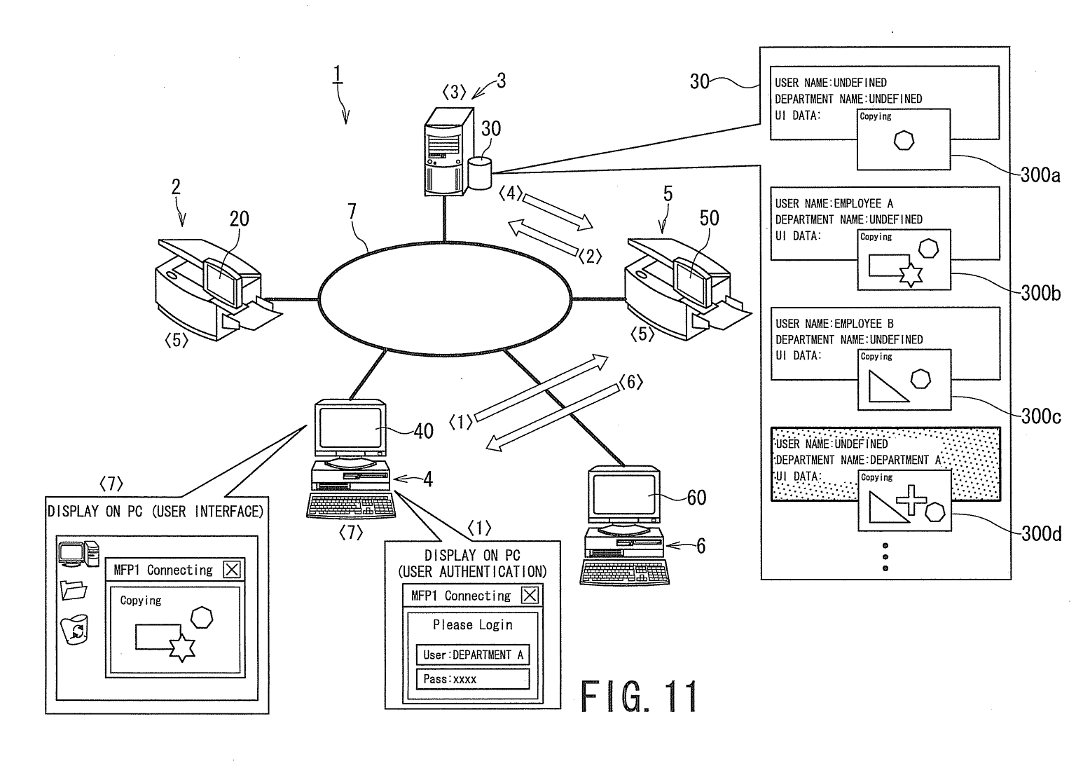

FIG. 11 is a diagram schematically showing, as in FIG. 10, on the diagram of the image forming system 1, a process until specific UI data is provided to the information processing apparatus 4 when the information processing apparatus 4 remotely operates the image forming apparatus 5. However, in FIG. 11, the department management function is set in the image forming apparatus 5 instead of the user management function.

In this case, in the information processing apparatus 4, the user inputs a department name and a password for department authentication (<1> in FIG. 11).

The image forming apparatus 5 passes the department name to the UI server 3 when the image forming apparatus 5 requests the UI server 3 to provide specific UI data (<2> in FIG. 11). The UI server 3 retrieves the specific UI data 300d from the UI database 30 with the department name (in this case, “department A”) as a key (<3> in FIG. 11).

The retrieved specific UI data 300d for the department A is passed to the information processing apparatus 4 through the image forming apparatus 5 (<4> in FIG. 11). The image forming apparatus 5 displays an indication “connected to the outside” (<5> in FIG. 11) and outputs the specific UI data 300d to the information processing apparatus 4 (<6> in FIG. 11). The information processing apparatus 4 realizes a user interface based on the specific UI data 300d.

In this case, as in the above case, the user interface common to the respective image forming apparatuses 2 and 5 is realized on the basis of the specific UI data 300d regardless of the original user interfaces of the image forming apparatuses 2 and 5. Therefore, convenience for all members belonging to the department A is improved.

### (3) Second Embodiment

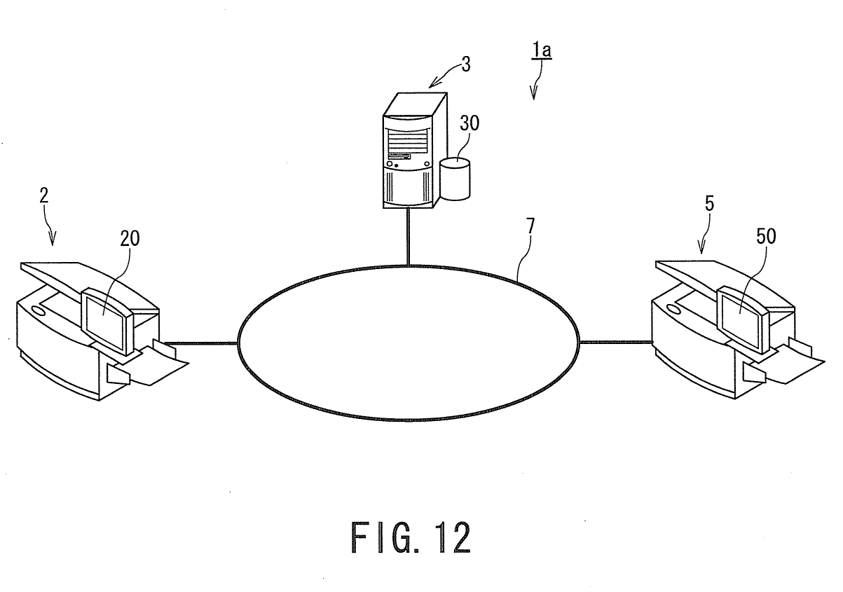

FIG. 12 is a diagram showing an example of the structure of an image forming system 1a according to a second embodiment of the present invention. The image forming system 1a adopts a form in which the plural image forming apparatuses 2 and 5 and the UI server 3 are connected through the network 7. In the first embodiment, the image forming apparatuses 2 and 5 are remotely operated using the client PCs (the information processing apparatuses 4 and 6). On the other hand, in the second embodiment, the respective image forming apparatuses 2 and 5 operate in a local mode using their own control panels 20 and 50. Since operations of the image forming apparatuses 2 and 5 according to this embodiment are the same, this embodiment is explained below with the image forming apparatus 2 as an example.

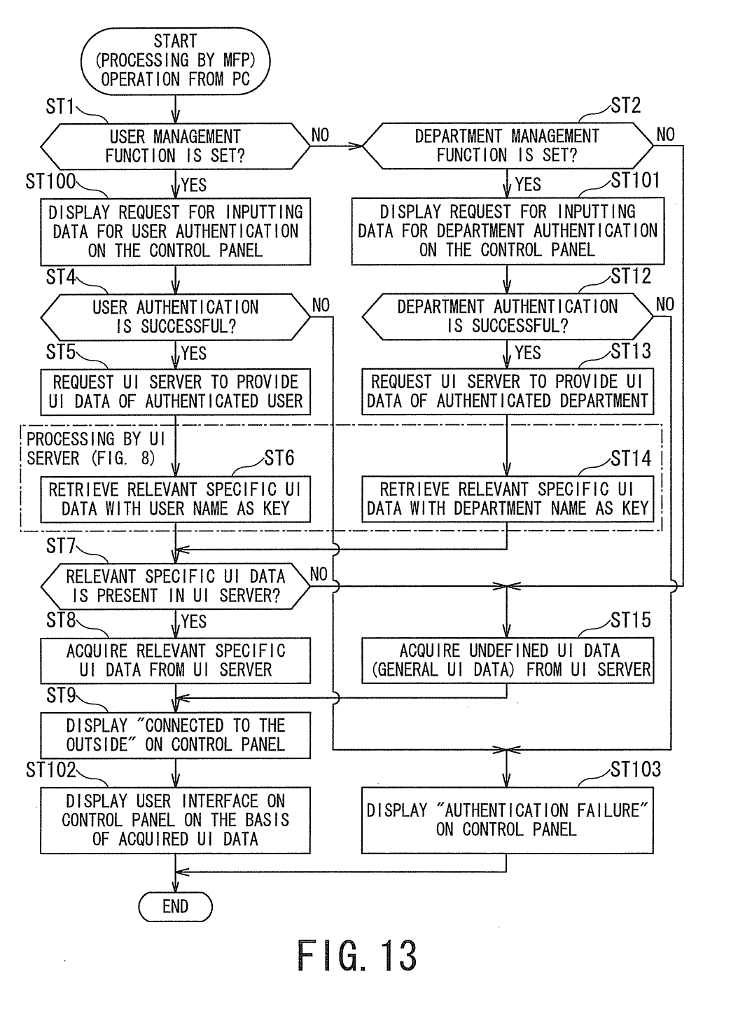

FIG. 13 is a flowchart showing an example of processing of the image forming apparatus 2 during a local mode operation. Processing same as that in the flowchart of the processing during the remote operation (FIG. 5) is denoted by the same step numbers and explanation of the processing is omitted.

The operation of the image forming apparatus 2 in the local mode is performed using the control panel 20 equipped in the image forming apparatus 2. Therefore, requests for data input for user authentication and department authentication are displayed on the control panel 20 (steps ST100 and ST101). Display and operation functions based on UI data acquired from the UI server 3 are applied to the control panel 20 of the image forming apparatus 2 (step ST102). The processing in the second embodiment is the same as that in the first embodiment except these steps.

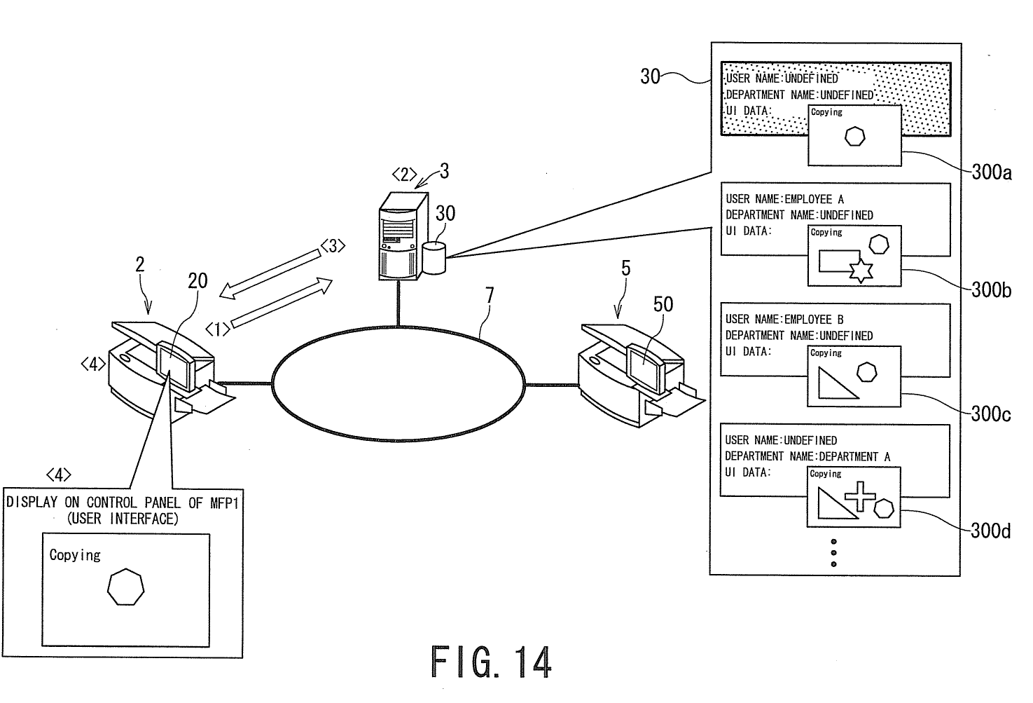

FIG. 14 is a diagram schematically showing, on a diagram of the image forming system 1a, a process until the general user interface is realized on the control panel 20 of the image forming apparatus 2 when the image forming apparatus 2 operates in the local mode.

When the user management function or the department management function is not set, the image forming apparatus 2 requests the UI server 3 to provide the general UI data 300a (<1> in FIG. 14).

The UI server 3 retrieves the UI data 300a from the UI database 30 (<2> in FIG. 14) and outputs the UI data 300a to the image forming apparatus 2 (<3> in FIG. 14).

The image forming apparatus 2 causes the control panel 20 to display a user interface image based on the UI data 300a and realizes an operation environment associated with an icon of the user interface image (<4> in FIG. 14). In this way, the user interface based on the general UI data 300a is realized on the control panel 20.

Although not specifically illustrated, the same user interface based on the common general UI data 300a is realized on the control panel 50 of the image forming apparatus 5 as well.

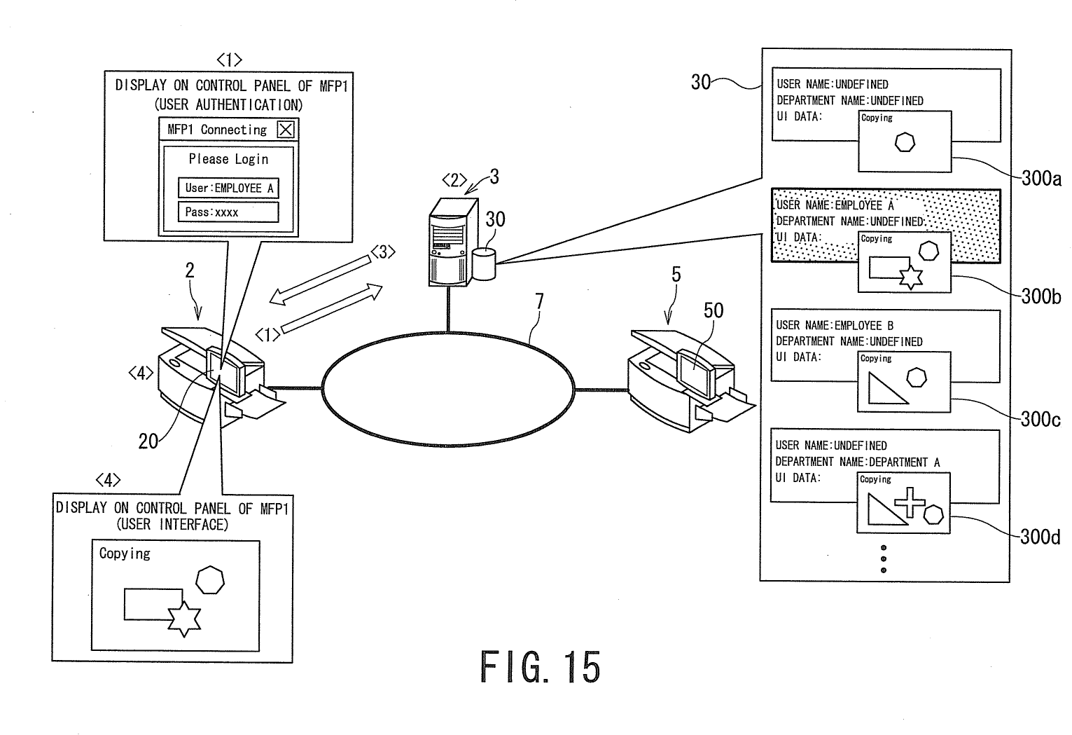

FIG. 15 is a diagram schematically showing, as in FIG. 14, on the diagram of the image forming system 1a, a process until the specific user interface is realized on the control panel 20 when the user management function is set in the image forming apparatus 2 that operates in the local mode.

When the user management function is set during the local mode operation, an input screen for user authentication is displayed on the control panel 20 of the image forming apparatus 2. A user inputs a user name (in an example in FIG. 15, “employee A”) and a password on this input screen. Thereafter, the image forming apparatus 2 performs user authentication based on the user name (employee A) and the password. When the authentication is successful, the image forming apparatus 2 requests the UI server 3 to provide the specific UI data 300b for the employee A. In this case, the image forming apparatus 2 sends the request together with the user name (employee A) (<1> in FIG. 15).

The UI server 3 retrieves the UI data 300b for the employee A from the UI database 30 (<2> in FIG. 15) and outputs the UI data 300b to the image forming apparatus 2 (<3> in FIG. 15).

The image forming apparatus 2 realizes a user interface based on the specific UI data 300b for the employee A on the control panel 20 (<4> in FIG. 15).

Although not explained here, the same user interface based on the specific UI data 300b for the employee A is realized on the control panel 50 of the image forming apparatus 5 as well.

Further, user interfaces based on the UI data 300c for another employee B and the UI data 300d for a department A are realized on the control panel 20 of the image forming apparatus 2 and the control panel 50 of the image forming apparatus 5 in the same manner.

As explained above, in the image forming systems 1 and la according to the respective embodiments, even when user interfaces of respective image forming apparatuses are originally different from each other, it is possible to realize, for each user or each department, a common user interface on an information processing apparatus and a control panel.

The present invention is not limited to the embodiments per se. At an implementation stage, elements of the present invention can be modified and embodied without departing from the spirit of the present invention. Various embodiments of the invention can be formed by appropriately combining the plural elements disclosed in the embodiments. For example, several elements may be deleted from all the elements disclosed in the embodiments. Moreover, elements described in the different embodiments may be appropriately combined.

What is claimed is:

1. An image forming system comprising:
plural image forming apparatuses equipped with control panels; and
a server that is connected to the respective image forming apparatuses through a network and manages data of a user interface commonly usable in the respective control panels of the respective image forming apparatuses and supplies the user interface to the respective image forming apparatuses.

2. An image forming system according to claim 1, wherein the respective image forming apparatuses realize display functions and operation functions of the respective control panels on the basis of the data of the user interface supplied from the server.

3. An image forming system according to claim 1, wherein the data of the user interface is data including data of images for operation displayed on the control panel, data concerning an arrangement of the images for operation, and data concerning functions associated with the images for operation.

4. An image forming system according to claim 1, wherein the data of the user interface is data including data of a specific user interface used when a specific user uses the respective image forming apparatuses and data of a general user interface used when an unspecified general user uses the respective image forming apparatuses.

5. An image forming system according to claim 4, wherein
the respective image forming apparatuses have user authenticating means,
when user authentication is performed, the respective image forming apparatuses request the server to provide the data of the specific user interface when authentication of the specific user is successful, and
when user authentication is not performed, the respective image forming apparatuses request the server to provide the data of the general user interface.

6. An image forming system according to claim 1, further comprising an information processing apparatus connected to the network, wherein
the respective image forming apparatuses request, according to a request from the information processing apparatus, the server to provide the data of the user interface, and
the respective image forming apparatuses provide the information processing apparatus with the data of the user interface provided by the server.

7. An image forming system according to claim 6, wherein the information processing apparatus realizes, on the basis of the data of the user interface supplied from the server via the image forming apparatuses, display functions and operation functions substantially the same as display functions and operation functions of the respective control panels.

8. An image forming system according to claim 6, wherein the respective image forming apparatuses display, when the respective image forming apparatuses are operated by the information processing apparatus that is provided with the data of the user interface, an indication that the image forming apparatuses are operated from the outside.

9. An image forming system according to claim 6, wherein the data of the user interface is data including data of a specific user interface used when a specific user uses the respective image forming apparatuses and data of a general user interface used when an unspecified general user uses the respective image forming apparatuses.

10. An image forming system according to claim 9, wherein
the respective image forming apparatuses have user authenticating means,
when user authentication is performed on the basis of authentication information inputted from the information processing apparatus, the respective image forming apparatuses request the server to provide the data of the specific user interface when authentication of the specific user is successful and provide the information processing apparatus with the specific user interface provided from the server, and
when user authentication is not performed, the respective image forming apparatuses request the server to provide the data of the general user interface and provide the information processing apparatus with the general user interface provided from the server.

11. A control method of an image forming system that includes plural image forming apparatuses equipped with control panels and a server connected to the respective image forming apparatuses through a network, the control method comprising the steps of:
managing, in the server, data of a user interface commonly usable in the respective control panels of the respective image forming apparatuses; and
supplying the data of the user interface from the server to the respective image forming apparatuses.

12. A control method of an image forming system according to claim 11, further comprising the step of realizing display functions and operation functions of the respective control panels on the basis of the data of the user interface supplied from the server.

13. A control method of an image forming system according to claim 11, wherein
the data of the user interface is data including data of a specific user interface used when a specific user uses the respective image forming apparatuses and data of a general user interface used when an unspecified general user uses the respective image forming apparatuses, and
the control method further includes the steps of:
when user authentication is performed, requesting the server to provide the data of the specific user interface when authentication of the specific user is successful; and
when user authentication is not performed, requesting the server to provide the data of the general user interface.

14. A control method of an image forming system according to claim 11, wherein
the image forming system further includes an information processing apparatus connected to the network, and
the control method further includes the steps of:
requesting, in response to a request from the information processing apparatus, the server to provide the data of the user interface; and
providing the information processing apparatus with the data of the user interface provided from the server.

15. A control method of an image forming system according to claim 14, further comprising the step of realizing, in the information processing apparatus, display functions and operation functions substantially the same as display functions and operations functions of the respective control panels on the basis of the data of the user interface supplied from the server via the image forming apparatuses.

16. A control method of an image forming system according to claim 14, further comprising the step of displaying, when the image forming apparatuses are operated by the information processing apparatus provided with the data of the user interface, an indication that the image forming apparatuses are operated from the outside on the respective control panels.

17. A control method of an image forming system according to claim 14, wherein
the data of the user interface is data including data of a specific user interface used when specific user uses the respective image forming apparatuses and data of a general user interface used when an unspecified general user uses the respective image forming apparatuses, and
the control method further includes the steps of:
when user authentication is performed on the basis of authentication information inputted from the information processing apparatus, requesting the server to provide the data of the specific user interface when authentication of the specific user is successful and providing the information processing apparatus with the specific user interface provided from the server; and
when user authentication is not performed, requesting the server to provide the data of the general user interface and providing the information processing apparatus with the general user interface provided from the server.
